(19) United States
(12) Patent Application Publication
(10) Pub. No.: US 2009/0134984 A1
(43) Pub. Date: May 28, 2009

(54) Car Poster that Changes Display Contents

(76) Inventor: Cheng-Ting Chen, Taipei (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/944,733

(22) Filed: Nov. 26, 2007

(51) Int. Cl. B60Q 1/00

(52) U.S. Cl. 340/425.5

(57) ABSTRACT

A car poster has a display device and a remote controller. The display device has a monitor that displays different contents according to different objectives. The remote controller transmits control signals to remotely control the monitor to change the display contents. A basic circuit of the display device has a controller, a memory, a receiver, a monitor, a connection port and a first power source. The controller is a control and operation center. The memory is used to previously stores multiple display contents and also is coupled to the controller. The receiver is coupled to the controller for receiving control signals from the remote controller.

### BACKGROUND OF THE INVENTION

1. Field of the Invention

The invention relates in general to a car poster that changes display contents, and more particularly to a display device configured on a windscreen to show messages to notify coming cars or pedestrians, wherein the display contents can be changed in accordance with different usage objectives.

2. Description of the Related Art

Nowadays cars have become common vehicles for every family or the public. Drivers often like to paste posters such as “baby in car” or “new driver” or the like at the car rear to notify other cars in the back. Moreover, drivers also would like to leave a message card of contact numbers on a front windscreen when the drivers park the cars on a private land, so that a landlord can get in contact with the drivers if required.

The conventional car posters are mostly stickers, placards, message cards or so on. However, the drivers may need to prepare different placards for different objectives, which is inconvenient.

### SUMMARY OF THE INVENTION

An objective of the present invention is to provide a car poster configured on a windscreen to show messages to notify coming cars or pedestrians. The car poster changes different display contents according to different usage objectives, so as to fulfill drivers' demands.

The car poster has a controller, a memory, a receiver and a monitor. The controller controls the receiver to receive multiple remote control signals, so as to select pre-stored display data in the memory to transmit the display data to the monitor to be displayed.

The remote controller has a control unit, a button device and a transmitter. An user inputs multiple control commands with the button device, and then the control unit sends out the control commands to the display device via the transmitter in a remote control manner, so as to change displayed contents of the display device.

### BRIEF DESCRIPTION OF THE DRAWINGS

FIG. 1 is a system diagram in accordance with the present invention;

FIG. 2 is a circuit block diagram of a display device in accordance with the present invention;

FIG. 3 is a circuit block diagram of a remote controller in accordance with the present invention; and

FIG. 4 shows a diagram when the display device is in use in accordance with the present invention.

### DETAILED DESCRIPTION OF THE INVENTION

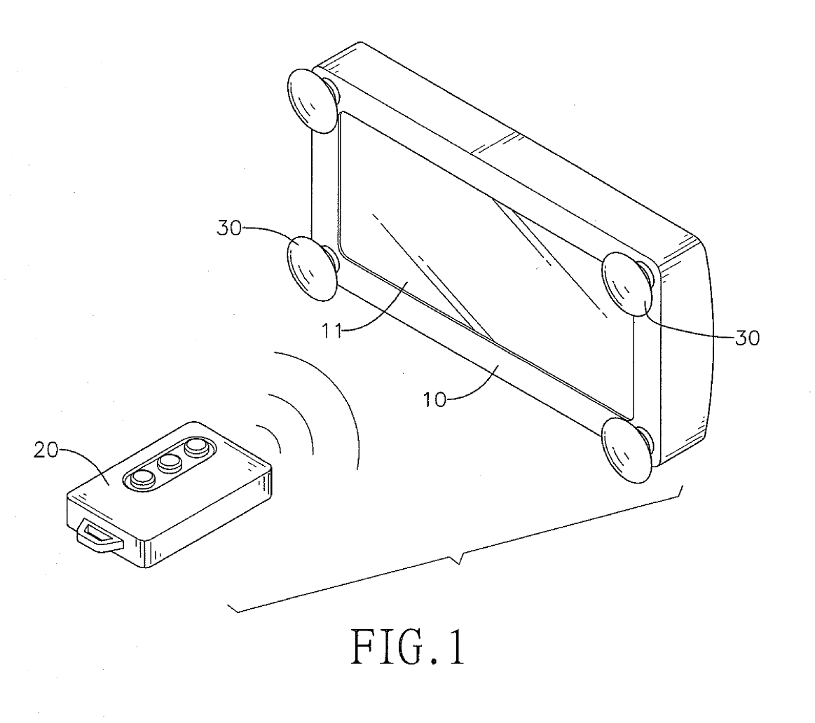

With reference to FIG. 1, a car poster in accordance with the present invention has a display device 10 and a remote controller 20. The display device 10 has a monitor 11 that displays different contents according to different objectives. The remote controller 20 transmits control signals to remotely control the monitor 11 to change the display contents. A preferred embodiment in accordance with the present invention is described as follows.

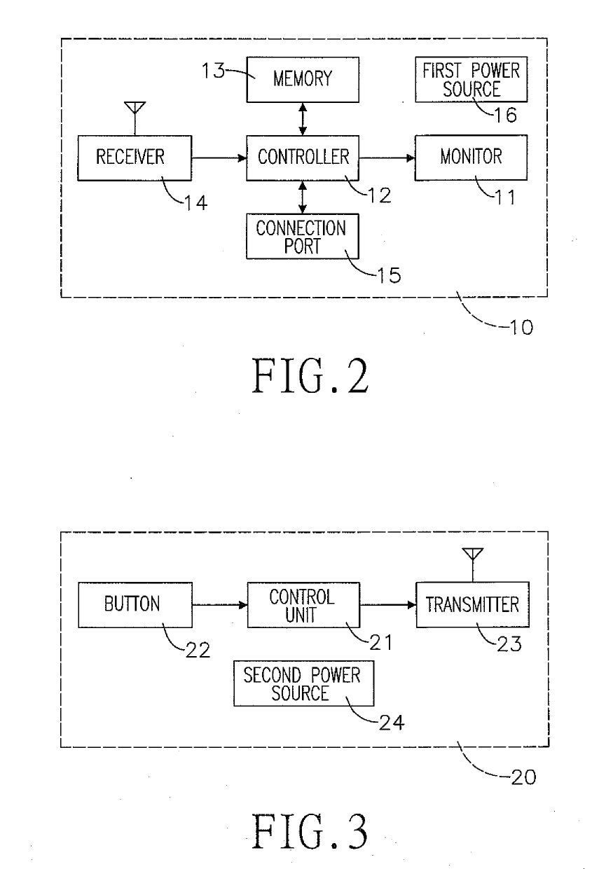

With reference to FIG. 2, a basic circuit of the display device 10 has a controller 12, a memory 13, a receiver 14, a monitor 11, a connection port 15, and a first power source 16.

The controller 12 is a control and operation center. The memory 13 stores multiple display contents and also is coupled to the controller 12. The receiver 14 is coupled to the controller 12 for receiving control signals from the remote controller 20. The receiver 14 may be a radio frequency (RF) receiver or an infrared receiver. The monitor 11 is coupled to an output terminal of the controller 12, so that the controller 12 drives the monitor 11 to display output data of the controller 12. The monitor 11 is made up by multiple matrix-arranged LEDs (light emitting diodes) or a monochromatic or chromatic LCD (liquid crystal display). The connection port 15 is coupled to the controller 12 to provide as an interface for the display device 10 to be coupled to external devices such as a computer, a PDA and the like, so as to update the stored data of the memory 13.

The first power source 16 provides working power for the aforesaid elements, which may a dry battery or a secondary cell.

With reference to FIG. 3, the remote controller 20 has a control unit 21, a button device 22, a transmitter 23, and a second power source 24. The button device 22 is coupled to an input terminal of the control unit 21 for users to input control commands to select the display contents. The transmitter 23 is coupled to an output terminal of the control unit 21 to send out the control commands to the display device 10. The transmitter 23 matches the receiver 14 of the display device 10, which may be a radio frequency (RF) transmitter or an infrared transmitter.

The second power source 24 provides working power for the aforesaid elements, which can be a dry battery or a secondary cell.

Furthermore, an operation method in accordance with the present invention is illustrated as follows.

When an user needs the display device 10 to display a specific message to notify coming cars or pedestrians, the user uses the button device 22 on the remote controller 20 to turn on the display device 10. Since the display device 10 previously stores the multiple display contents, the user uses the remote controller 20 to select one of them to display. Thereby the selected message contents that are stored in the memory 13 such as “baby in car”, “sorry for parking here for a while”, “new driver” and so on is displayed on the monitor 11 of the display device 10 via a transmission control command. Since the display device 10 previously stores the multiple display contents to be used for the different objectives, the display device 10 can fulfill drivers' demands to notify other people.

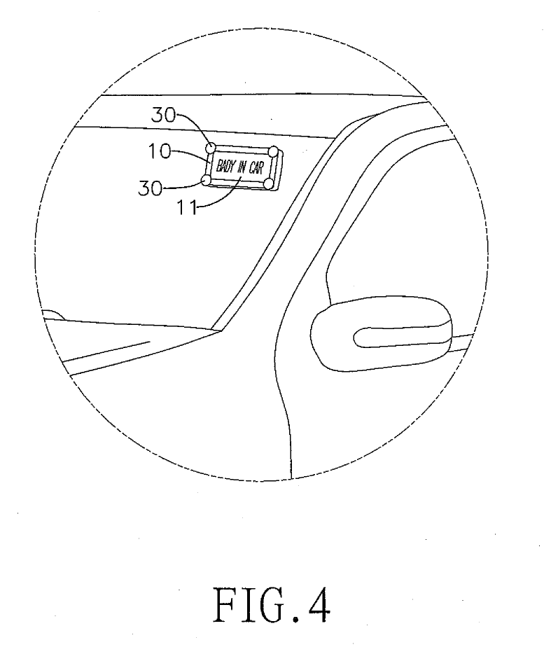

Since the display device 10 of present invention is used to fulfill the drivers' demands to notify other people according to different objectives, a position to configure the display device 10 can be on an internal side of a front windscreen to or on an internal side of a back windscreen. For example, if the driver wants to park a car and show the message “sorry for parking here for a while”, the display device 10 is suitable to be configured on the internal side of the front windscreen. On the other hand, if the driver wants to show the message content “baby in car” to notify other cars in the back, the display device 10 is suitable to be configured on the internal side of the back windscreen. In order to achieve the aforesaid objectives, the display device 10 is designed to be easy to configure and remove with at least a sucker 30 configured on outside the display device 10. With reference to FIG. 4, the suckers 30 make the display device 10 stabled on the appropriate positions on the windscreen. Since the suckers 30 have a good attachment force, the suckers 30 not only provides a good attachment effect to the display device 10, but also facilitate the display device to be configured or removed conveniently.

Therefore, the preferred embodiment of the present invention can be clearly understood from the above descriptions. The objective of the present invention is to provide the display device configured on a windscreen to show messages to notify the coming cars or pedestrians. The display contents can be changed in accordance with different usage objectives, so as to fulfill the drivers' demands.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A car poster that changes display contents comprising:
a display device having
a controller;
a memory storing multiple display contents and coupled to the controller;
a receiver coupled to the controller for receiving control signals; and
a monitor coupled to an output terminal of the controller, wherein the controller drives the monitor to display output data of the controller; and
a remote controller having
a control unit;
a button device coupled to an input terminal of the control unit for users to input control commands to select the display contents; and
a transmitter coupled to an output terminal of the control unit to output control signals to the receiver of the display device.

2. The car poster that changes display contents as claimed in claim 1, wherein the monitor of the display device is made up by a plurality of matrix-arranged light emitting diodes.

3. The car poster that changes display contents as claimed in claim 1, wherein the receiver of the display device is a radio frequency receiver or an infrared receiver; wherein the transmitter of the remote controller is a radio frequency transmitter or an infrared transmitter.

4. The car poster that changes display contents as claimed in claim 1, wherein the display device and the remote controller further comprise a power source respectively to provide working power.

5. The car poster that changes display contents as claimed in claim 4, wherein the power source is a battery or a secondary cell.

6. The car poster that changes display contents as claimed in claim 1, wherein the display device further comprises a connection port, wherein the connection port is coupled to the controller.

7. The car poster that changes display contents as claimed in claim 1, further comprising at least a sucker configured on outside the display device.

8. The car poster that changes display contents as claimed in claim 2, further comprising at least a sucker configured on outside the display device.

9. The car poster that changes display contents as claimed in claim 3, further comprising at least a sucker configured on outside the display device.

10. The car poster that changes display contents as claimed in claim 4, further comprising at least a sucker configured on outside the display device.

11. The car poster that changes display contents as claimed in claim 5, further comprising at least a sucker configured on outside the display device.

12. The car poster that changes display contents as claimed in claim 6, further comprising at least a sucker configured on outside the display device.
